(19) United States
(12) Patent Application Publication
(10) Pub. No.: US 2002/0122110 A1
(43) Pub. Date: Sep. 5, 2002

(54) Method and apparatus for providing a supplementary call service

(75) Inventor: Juha Rasanen, Espoo (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/078,250

(22) Filed: Feb. 15, 2002

Related U.S. Application Data
(63) Continuation of application No. PCT/EP99/06758, filed on Sep. 13, 1999.

(51) Int. Cl. H04N 7/14; H04M 1/24; H04M 3/42

(52) U.S. Cl. 348/14.01; 379/32.01; 379/201.01

(57) ABSTRACT

The present invention relates to a method and apparatus for providing a supplementary call service in a telecommunication network, wherein a negotiation signaling between end terminals of respective call parties is monitored on the signaling path between the end terminals, and a connection information is detected during said monitoring is stored as a preparatory measure. The detected and stored connection information is used to generate a signaling for establishing the supplementary call service, when the supplementary call service is invoked by one of the call parties. Thereby, required connection parameters can be derived from the traffic channel, such that a supplementary service information can be sent at a later stage by using a correct signaling determined on the basis of the stored connection information.

### CROSS-REFERENCE TO RELATED APPLICATION

This application is a continuation of International Application PCT/EP99/06758 having an international filing date of Sep. 13, 1999 and from which priority is claimed under all applicable sections of Title 35 of the United States Code including, but not limited to, Sections 120, 363 and 365(c).

### FIELD OF THE INVENTION

The present invention relates to a method and apparatus for providing a supplementary call service in a telecommunication network, such as a UMTS (Universal Mobile Telecommunications System) or GSM (Global System for Mobile Communications) network.

### BACKGROUND OF THE INVENTION

In recent years, multimedia telephone terminals which can be connected to fixed networks have been developed. These terminals provide real-time video, audio or data or any combination thereof, between two multimedia telephone terminals over a voice band network connection. Communication may be either one-way or two-way. The multimedia-telephone terminals can be integrated into PCs or workstations, or can be stand-alone units.

For packet based multimedia applications, a call hold supplementary service and a call transfer supplementary service are defined in the ITU-T recommendations H.450.4 and H.450.2, respectively. According to these recommendations, a continuous signaling for information and synchronization purposes is required to be generated in the multimedia end terminals according to the respective protocol features.

Interworking with such multimedia applications in mobile radio networks is defined in the ITU-T video/multimedia recommendation H.324/M. However, in circuit switched mobile radio networks, some supplementary call services are only applicable to speech calls but not to data calls. A reason for this is that data transmission protocols both in the network and on the application level will fail if the peer entity disappears, e.g. when the call is put on hold, or if the characteristics of the peer entity change, e.g. when the call is transferred. Consequently, the original connection will permanently fail, e.g. it cannot be re-established from the hold condition.

Currently, a video/multimedia service is being specified for GSM and UMTS, wherein the video/multimedia call is technically a data call but by nature a human to human call like a conventional speech call. Consequently, supplementary call services will be equally useful and important for video/multimedia calls as for speech calls.

For example, a call hold supplementary service is defined in the GSM specification GTS 02.83. According to this specification, the call hold service allows a served mobile subscriber, who is provisioned with this supplementary service, to interrupt communication on an existing active call and then subsequently if desired, re-establish communication. The traffic channel remains assigned to the mobile subscriber after the communication is interrupted to allow the origination or possible termination of other calls. When the call hold service is invoked, communication is interrupted on the traffic channel and the traffic channel is released from the existing call. The traffic channel is reserved for the served mobile subscriber invoking the call hold service. The served mobile subscriber can only have one call on hold at a time.

Furthermore, an explicit call transfer (ECT) supplementary service is defined in the GSM specification GTS 02.91. According to this recommendation, the ECT supplementary service enables the served mobile subscriber (subscriber A) who has two calls, each of which can be an incoming or outgoing call, to connect the other parties in the two calls and release the served mobile subscriber's own connection. Prior to transfer, the connection shall have been established on the call between subscriber A and subscriber B. On the call between subscriber A and subscriber C, either the connection shall have been established prior to transfer, or, as a network option, transfer can occur while subscriber C is being informed of the call (i.e. the connection has not yet been established). On successful invocation of ECT supplementary service, the two calls between subscriber A and subscriber B and between subscriber A and subscriber C, respectively, shall be removed from the access of the subscriber A (i.e. the traffic channel and the signaling channel towards subscriber A will be released) and shall be transformed into a normal call between subscriber B and subscriber C, wherein the state of the previously held party is changed to active without a subscriber action. After receipt of an ECT request from the served subscriber, the visitor location register (VLR) of the serving mobile switching center (MSC) will check if the ECT supplementary service is provisioned for the served subscriber. Moreover, the VLR will also check barring causes and other restrictions If the outcome of these checks is successful, both calls are connected in the MSC, wherein the held party will be retrieved and both remote parties will be notified that call transfer was done. After that, the served mobile subscriber will be disconnected from both calls. If the above checks fail, the ECT request will be rejected and the two calls remain in the call states in which they were before ECT was attempted.

In general, the above and other supplementary services can be invoked by entering a corresponding procedure information at the MMI (Man Machine Interface) of a mobile terminal. The procedure information comprises a service code and a supplementary information. The service code uniquely specifies the supplementary service, either as a defined GSM supplementary service or as a spare service code. All spare service codes can be reserved for future use. The supplementary information may comprise e.g. a PIN code or a directory number. For further information, it is referred to the GSM specification GTS 02.30.

### SUMMARY OF THE INVENTION

It is an object of the present invention to provide a method and apparatus for providing supplementary call services in video/multimedia calls.

This object is achieved by an interworking method for providing a supplementary call service in a telecommunication network, comprising the steps of:

monitoring on a signaling path between end terminals a negotiation signaling between respective call parties;

storing a connection information detected in said monitoring step;

using said detected connection information to generate a signaling towards at least one of said end terminals to establish said supplementary service, when said supplementary service is invoked by one of said call parties.

Furthermore, the above object is achieved by an apparatus for providing a supplementary call service in a telecommunication network, comprising:

monitoring means for monitoring on a signaling path between end terminals a negotiation signaling of respective call parties;

storing means for storing a connection information detected by the monitoring means;

signaling means for generating a signaling towards at least one of said end terminals to establish the supplementary call service in response to the stored connection information, when the supplementary call service is invoked by one of the called parties.

Accordingly, the inband and/or outband negotiation between the call parties is initially monitored at a location between the respective end terminals and stored in order to be used for establishing a later supplementary call service in case the supplementary call service is provided between connections with different parameters. Thus, a correct protocol signaling can be provided to e.g. a multimedia end terminal regardless of the protocols used in the network or the other end terminal. Moreover, the supplementary call service can be set even if a subscriber could not be informed via the conventional signaling channel. This is especially valuable in cases where not enough intelligent signaling protocol is available for the end-to-end signaling.

Preferably, the supplementary call service may be a call hold supplementary service or an explicit call transfer supplementary service.

In case of a call hold supplementary service, the signaling for establishing the supplementary service may comprise sending empty or fill frames or supervisory data link layer frames according to the connection information to one of the call parties, in order to keep a connection protocol alive. Thus, the HOLD and the Media on Hold (MOH) information can be sent using the correct protocol; that is, whatever protocols are used in the terminals. Furthermore a related timer and resynchronization attempts towards one of the call parties can be stopped in order to prevent a call failure.

Preferably, the signaling for establishing the call hold supplementary service may comprise sending a video information and/or an audio information to one of the call parties. Thus, a still or moving video and/or an audio announcement can be sent towards the video/multimedia terminal to indicate the call hold condition or to deliver any other relevant information.

The signaling for establishing the call hold supplementary service can be generated by a mobile terminal. Thereby, a corresponding call hold supplementary service can be provided by a mobile phone to a multimedia terminal such as a PC connected to the mobile phone.

Furthermore, the supplementary call service may be a call transfer supplementary service. In this case, the signaling for establishing the call transfer supplementary service may comprise a fallback signaling for converting a connection to one of the call parties into a speech mode.

Thus, a multimedia/video connection can be converted into a speech mode using a correct signaling, such that a call transfer, e.g. an ECT, to a speech call can be established. If the two data calls to be transferred cannot be adapted, the fallback signaling may be performed towards both call parties. Furthermore, a coded parameter derived from the connection information may be transmitted to a network element having a transcoding capability, e.g. to an MSC, in order to provide a required transcoding function at the network element. This signaling may be performed if the fallback signaling to one of the call parties has failed.

Furthermore, changes of call characteristics of the transferred calls may be indicated to an upper layer entity, e.g. an upper layer interworking function, such that an application level compatibility can be recognized and interworking can be performed in the upper layer entity.

The signaling for establishing the supplementary service may be performed by an interworking function of an interworking unit provided in the telecommunication network.

### BRIEF DESCRIPTION OF THE DRAWINGS

In the following, the present invention will be described in greater detail on the basis of a preferred embodiment with reference to the accompanying drawings, in which:

FIG. 1 shows a basic block diagram of a connection between multimedia terminals via a mobile and a fixed network;

FIG. 2 shows a basic block diagram of an apparatus for providing a supplementary service, according to the preferred embodiment of the present invention;

FIG. 3 shows a flow diagram of a method for providing a call hold supplementary service, according to the preferred embodiment of the present invention, and

FIG. 4 shows a flow diagram of a method for providing an ECT supplementary service according to the preferred embodiment of the present invention.

### DESCRIPTION OF THE PREFERRED EMBODIMENT

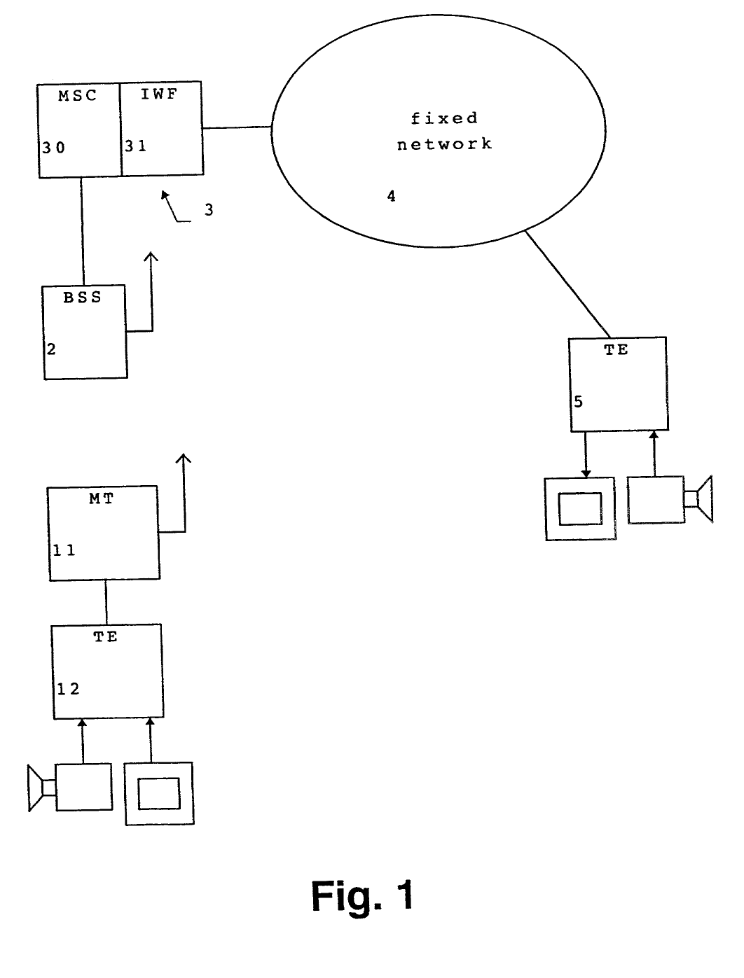

In the following, the present invention will be described on the basis of a preferred embodiment which relates to a multimedia connection between a fixed network 4 and a GSM or UMTS network, as shown in FIG. 1.

According to FIG. 1, a multimedia end terminal (TE) 5 is connected via the fixed network 4, e.g. a Public Switched Telephone Network (PSTN), IP network or the like, to a mobile terminal (MT) 11 which may be a mobile telephone. The mobile terminal 11 is connected to a multimedia terminal equipment (TE) 12 such as a Personal Computer (PC). The MT 11 is radio-connected to a Base Station Subsystem (BSS) 2 which is connected to a Mobile Switching center (MSC) 30 having an allocated interworking function (IWF) 31. The IWF 31 is provided e.g. for adapting protocol features of the mobile network to protocol features of the fixed network 4.

Generally, the TEs 5 and 12 disclosed in FIG. 1 may correspond to any multimedia or video equipment which can be connected to a telecommunication network.

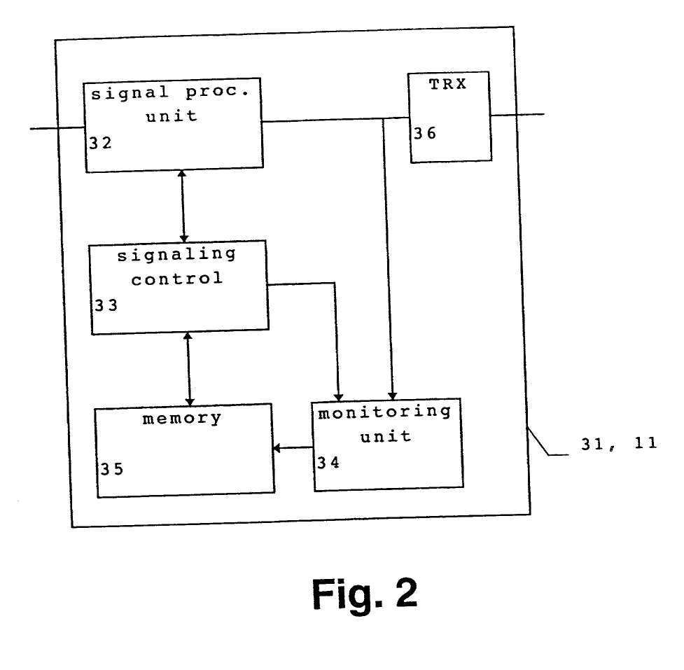

FIG. 2 shows a basic block diagram of an apparatus or device for providing a supplementary call service. According to the preferred embodiment, this apparatus corresponds to the IWF 31 and/or to the MT 11, shown in FIG. 1. However, the apparatus according to FIG. 2 may also be arranged at a separate location within the mobile network or the fixed network 4. Furthermore, it is to be noted that only those parts of the IWF 31 or the MT 11 relevant to the present invention are included in the basic block diagram shown in FIG. 2.

According to FIG. 2, the IWF 31 or the MT 11 comprise a transceiver of (TRX) 36 for transmitting/receiving speech or data calls to/from the fixed network 4 or the TE 12, respectively. Thus, the TRX 36 comprises a transmitting and a receiving function so as to achieve a bidirectional data or speech transmission via the fixed network 4 or, respectively, the radio path of the mobile network.

Furthermore, a signal processing unit 32 is connected to the TRX 36. In case the apparatus shown in FIG. 2 corresponds to the IWF, the 31 signal processing unit 32 comprises interworking resources (e.g. video and/or audio functions, modem functions etc.) required for adapting data or speech calls to/from the fixed network 4 to data or speech calls to/from the mobile network.

In case the apparatus shown in FIG. 2 corresponds to the MT 11, the signal processing unit 32 comprises signal processing resources (speech and/or channel transcoding functions, multiplexing/demultiplexing functions, equalizing functions etc.) required for transmitting/receiving speech or data calls to/from the multimedia TE 12.

The signal processing unit 32 is controlled by a signaling control unit 33 which performs controls so as to ensure the required signaling according to the protocols use at the input and output side of the apparatus. Furthermore, a monitoring unit 34 with a kind of sniffing function is provided for extracting or monitoring connection parameters of the connections connected via the apparatus. In particular, the connection parameters may comprise a type of audio or video codecs used in the respective connections, a type of video or audio coding protocol or data transmission protocol and related parameters. The extracted or monitored connection parameters may be received through an inband signaling and/or and outband signaling controlled by the signaling control unit 33. The monitoring unit 34 is connected to a memory 35 arranged to store the monitored or extracted connection parameters. The memory 35 may be any writable volatile or non-volatile memory, e.g. a RAM, EPROM, or flash memory.

According to the preferred embodiment, the signal control unit 33 is adapted to read the memory 35, when an invocation of a supplementary call service has been received by the signal processing unit 32. Based on the read connection information, the signaling control unit 33 controls the signal processing unit 32 so as to generate the signaling or signal processing functions required according to the characteristics of the input and output connections. Thus, the provision of a supplementary call services is possible even if the protocols, codings or other parameters of the connected terminals are different.

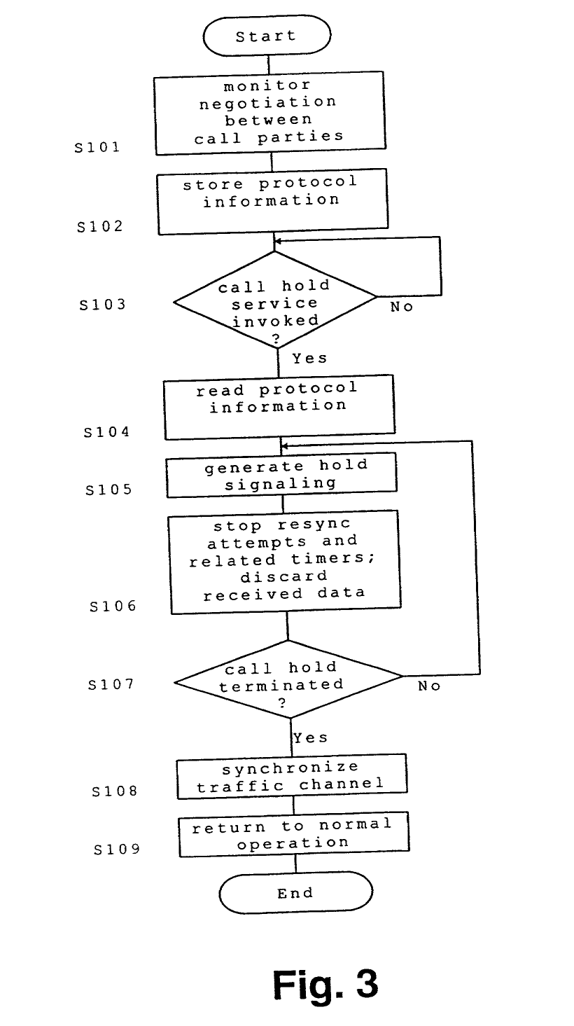

In the following, a call hold supplementary service is described with reference to the flow diagram shown in FIG. 3. In particular, the flow diagram according to FIG. 3 is first described for the case that the apparatus according to FIG. 2 corresponds to the IWF 31 (network side), and then for the case that the apparatus according to FIG. 2 corresponds to the MT 11 (mobile side).

Initially, the following preparatory measures are taken before any call hold service is invoked. The monitoring unit 34 monitors the inband negotiation (ITU-T V.8/V.8bis/V.140 or H.245 or corresponding ones) between the video/multimedia TEs 12 and 5 to derive the used protocols, e.g. video coding protocol, audio coding protocol, data transmission protocol, and related parameters (step S101). The IWF 31 may receive at least a part of this information through an additional outband signaling. Then, the monitoring unit 34 is controlled by the signal control unit 33 to store the monitored or extracted connection information in the memory 35, to be used at a later stage during a possible call hold activation and condition (step S102). Then, the signaling control unit 33 checks whether the signal control unit 32 has received an invocation of a call hold service (step S103). This check is repeated until a call hold invocation has been received. It is to be noted that the flow diagram according to FIG. 3 only comprises those steps relevant for the provision of the call hold service. Thus, other processings may be performed by the signaling control unit 33 during the waiting cycle.

If an indication of a call hold invocation has been received by the signal processing unit 32 from the MSC 30, the signaling control unit 33 reads the protocol information stored in the memory 35 (step S104), and performs a control so as to generate a hold signaling for keeping alive the protocols towards the fixed network 4 (step S105). The minimum functionality to be provided by the IWF 31 is to keep sending empty or fill frames or supervisory data link layer frames according to the used data link layer protocol specification, e.g. RR/RNR (Receiver Ready/Receiver Not Ready) frames in case of an HDLC based protocol. Furthermore, the signaling control unit 33 of the IWF 31 performs control so as to stop resynchronization attempts towards the MT 11 and to stop any related timers in order to prevent a call failure (step S106).

Alternatively instead of just keeping the far end protocol entity alive, the signaling control unit 33 may use the protocol and parameter information read from the memory 35 to send a still or moving video and/or an audio announcement stored in the memory 35 or in an other memory towards the fixed network, i.e. the far end terminal 5, by using the relevant video, audio and transmission protocols Thereby, the call hold condition can be indicated to the multimedia terminal 5. Moreover, any other relevant information can be delivered thereto. Thereby, the terminal 5 can be informed of the call hold condition and a corresponding still picture or video sequence can be displayed on the display terminal of the TE 5.

During the call hold condition the signaling control unit 33 controls the signaling processing unit 32 so as to discard user data (e.g. continuous video and/or audio information) received from the TE 5 via the fixed network 4. When the mobile subscriber, i.e. MT 11, terminates the call hold condition and re-establishes the call, the MSC 30 informs the IWF 31 about the change. The signaling control unit 33 checks whether the call hold condition has been terminated (step S107). If not, the processings of steps S105 and S106 are repeated. If the signaling control unit 33 determines that the call hold condition has been terminated, it controls the signal processing unit 32 so as to synchronize the traffic channel towards the MT 11 (step S108). Furthermore, the signaling control unit 33 stops the alive measures and announcement sendings towards the TE 5 and returns the traffic channel to the normal operation (S109). Then, the provision of the call hold service is terminated.

An example for the above described operation is the case where the mobile subscriber of the MT 11 puts an ongoing video call on hold, makes a speech call to another number, terminates the speech call and re-establishes the video call.

The mobile terminal MT 11 may as well apply the keep alive measures shown in FIG. 3 towards its terminal TE 12. As in the above case, the memory 35 provided in the MT 11 stores the connection information derived by the preparatory monitoring of the inband negotiation between the video/multimedia call parties, to be used later during the call hold activation and condition. When the signaling control unit 33 of the MT 11 recognizes the activation or invocation of the call hold condition, it starts keeping alive the protocols towards the TE 12 by performing the operations described in steps S105 and S106 of FIG. 3. In particular, the MT 11 may provide the minimum functionality or may send a stored still or moving video and/or audio announcement to the TE 12, to thereby indicate on the screen of the subscriber that the application is still alive during the call hold condition.

Furthermore, the signaling control unit 33 performs a control so as to discard user data (e.g. continuous video and/or audio information) received from the TE 12 during the call hold condition (step S106). When the call hold condition is terminated and the call is re-established, the signaling control unit 33 performs a control so as to synchronize the traffic channel towards the network and to stop the alive measures and announcement sendings towards the TE 12, and to return the traffic channel to the normal operation (steps S108 and S109).

In case a call hold invocation is activated towards the MT 11 by the TE 5 or any other fixed or mobile terminal, the same processing shown in FIG. 3 is performed in the IWF 31 but the fixed network 4 and the mobile network have changed places, i.e. the IWF 31 performs the keep alive measures (step S106) towards the mobile terminal MT 11.

Accordingly, as described above, a call hold supplementary service can be provided in a mobile video/multimedia call e.g. in a GSM or a UMTS network.

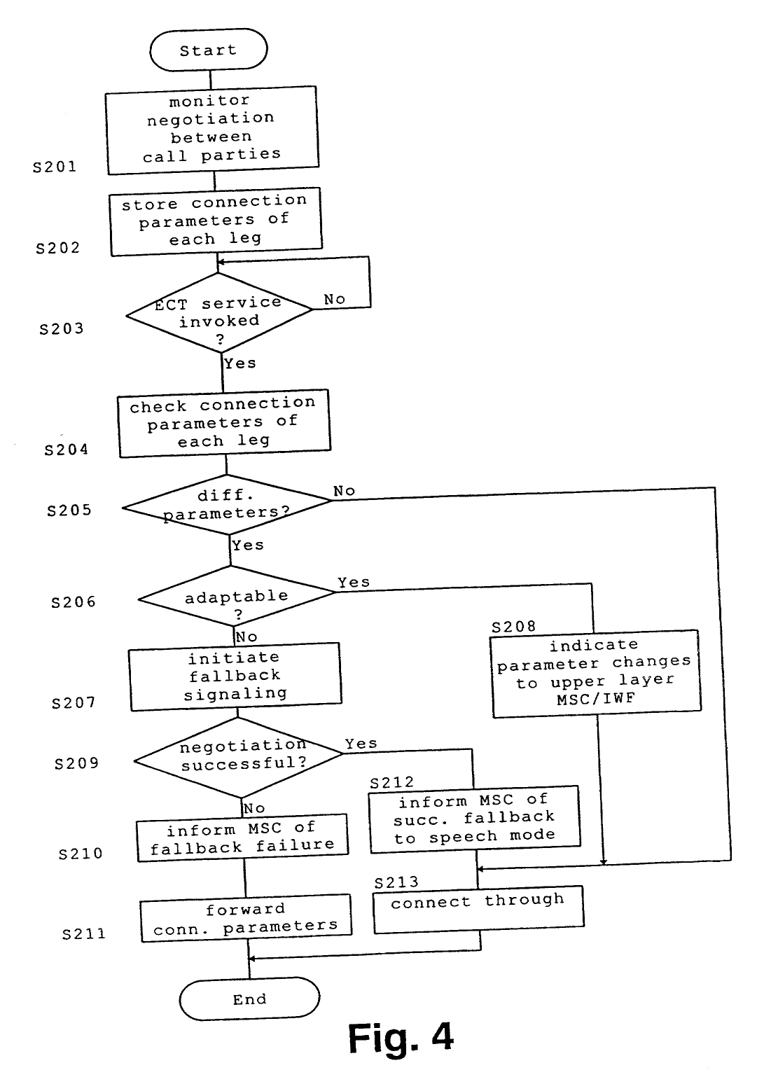

In the following, an explicit call transfer (ECT) supplementary service of video/multimedia calls is described as an example for a call transfer supplementary service, with reference to the flow diagram shown in diagram FIG. 4. The processing relating to the ECT supplementary service can be performed in the IWF 31 having the arrangement shown in FIG. 2.

As preparatory measures, the monitoring unit 34 of the IWF 31 monitors the inband negotiations between the video/multimedia call parties and stores the results in the memory 35 (step S201 and S202). The connection information may comprise a type of audio codec, a type of video codec or the like. The connection information or parts of it may as well be received through an outband signaling.

The MSC 30 knows the services/call types (video/data and speech) of each connection portion (leg) of the explicit call transfer from the setups sent by the calling party.

In step S203, the signaling control unit 33 of the IWF 31 determines whether an indication of an invocation of an ECT service has been received by the signal processing unit 32 from the MSC 30. If not, step S203 is repeated. When the TE 12 activates the ECT service, the MSC 30 indicates the service invocation to the signal processing unit 32, such that the signaling control unit 33 determines an invocation of the ECT service in step S203. Then, the signaling control unit 33 checks the connection parameters stored in the memory 35 so as to determine the service definitions (S204). Thereafter, the signaling control unit 33 of the IWF 31 compares the connection parameters so as to recognize any difference.

Alternatively, the MSC 30 may check the service definitions by requesting a corresponding information from the signaling control unit 33 of the IWF 31. Then, the MCS may recognize any difference between the connection parameters, and may supply a corresponding control command to the IWF 31, such that the signaling control unit 33 provides a corresponding signaling.

In case both connections (A to B and A to C) are on (i.e. called party has answered), one of the connections (i.e. the connection to B) is on hold, and both connections have been set up with the same parameters, i.e. they employ the same bearer service with the same parameters, no difference of the connection parameters is determined in step S205. The same applies to the case that the connection A to B is on hold, the connection A to C is alerting at C when A goes on hook, and the connection A to C is set up with the same parameters as the connection A to B, wherein possible inband negotiation does not change the correct characteristics.

In the above cases, the operation proceeds to step S213 and the resources of the signal processing unit 32 of the IWF 31 are released and by-passed, i.e. the IWF 31 is connected through in step S213. In other respects, the ECT service operates according to the current standards defined in the respective GSM specifications.

In case different connection parameters are detected in step S205, the MSC 30 or the signaling control unit 33 of the IWF 31 determine whether different connection parameters are adaptable at an upper protocol level. This is the case, when the connections (A to B and A to C) have been set up with different parameters and are both video calls but with different characteristics, e.g. one connection is a UDI call and the other is a modem call.

If it is determined in step S206, that the different parameters are adaptable, the operation proceeds to step S208, where the possible parameter changes of the video/audio characteristics are indicated to an upper layer MSC/IWF entity. The upper layer MSC/IWF entity recognizes the application level compatibility of the connection legs (to B and to C) and the need for interworking (e.g. due to the one leg being a UDI leg and the other employing a modem). Then, the IWF entities are connected via a group switch (GSW) which leads to a connection configuration “party B—IWF 31 for B—GSW—IWF 31 for C—party C”. Then, the IWF 31 is connected through in step S213.

In case the different parameters are not adaptable, since one connection is a speech call and the other a video call or both connections are video calls but with unadaptably different characteristics (e.g. different data rates), the operation proceeds to step S207, where the signaling control unit 33 initiates a fallback signaling. As already mentioned, this initiation may also be performed by the MSC 30. The fallback signaling may be e.g. an ITU-T V.8bis inband signaling towards the B party (e.g. TE 5) in order to convert the connection to a speech mode.

In step S209, the signaling control unit 33 determines whether the fallback negotiation was successful or not. If so, the signaling control unit 33 controls the signal processing unit 32 so as to inform the MSC 30 about the results (step S212). Then, the MSC 30 releases the IWF resources and establishes a through connection of the traffic channel between the B and C parties (step S213).

If the determination in step S209 indicates that the fallback negotiation was not successful, e.g. because the B party does not support such a negotiation mechanism, the signaling control unit 33 of the IWF 31 controls the signal processing unit 32 so as to inform the MSC 30 of the failure of the fallback negotiation (S210) and forwards the characteristics of the required audio codec to the MSC 30 (step S211). Then, the MSC 30 provides the call with appropriate transcoder (TC) resources capable of performing a conversion between the speech codings of parties B and C. The call between the parties B and C is then set up as a speech call with a configuration “speech in a speech channel between the party C and the TC, speech with a different coding scheme in a video channel between the party B and the IWF 31,” wherein (at least) the speech coding is transmitted between the TC of the MSC 30 and the IWF 31, to thereby terminate the ECT service function.

However, a problem might arise if the connection A to B is on hold, and the connection A to C is alerting at C when A goes on hook. In this case, the connection A to C may be set up with the same parameters as the connections A to B, and an inband negotiation may lead to different characteristics, e.g. the connection A to B may be 64 kbit/s UDI but the connection to C falls back to a 28.8 kbit/s modem link or to a speech call. As an alternative, the connection A to C may be set up with different parameters than the connection A to B.

In the above special cases, the A party goes on hook before the C party answers. Thus, the signaling control unit 33 of the IWF 31 may be adapted to perform control so as to establish a handshake with the C party and to replace the missing A party in a possible inband negotiation (e.g. an ITU-T V.140 inband negotiation). The signaling control unit 33 may then use default parameters compatible with the call set up by the A party. The results of the inband negotiation are indicated to an upper layer MSC/IWF entity which then operates as in the case of the above described step S205 and following ones, depending on the characteristics of the connection legs to B and C.

Accordingly the above operations enable the provision of the ECT supplementary call service in a mobile video/multimedia call of e.g. a GSM or UMTS network.

It is to be noted, that the processings described with reference to FIGS. 3 and 4 and performed by the respective blocks of the block diagram shown in FIG. 2 may be implemented by a control program of a microprocessor such as a CPU provided in the IWF 31 or the MT 11, wherein the respective blocks 32 to 34 are replaced by corresponding software features or routines provided in a program memory allocated to the CPU.

Furthermore, the method and apparatus for providing the supplementary call services as described in the above preferred embodiment may be provided for any supplementary call service in any telecommunication network comprising terminal equipments supporting different types of connections, and is not restricted to a mobile network. In particular, the apparatus disclosed in FIG. 2 may be arranged at any location of a telecommunication network and shall not necessarily correspond to an IWF or MT. The above description of the preferred embodiment and the accompanying drawings are only intended to illustrate the invention. The preferred embodiment of the invention may vary within the scope of the attached claims.

In summary, the present invention relates to a method and apparatus for providing a supplementary call service in a telecommunication network, wherein a negotiation signaling between end terminals of respective call parties is monitored on the signaling path between the end terminals, and a connection information detected during said monitoring is stored as a preparatory measure. The detected and stored connection information is used to generate a signaling for establishing the supplementary call service, when the supplementary call service is invoked by one of the call parties. Thereby, required connection parameters can be derived from the traffic channel, such that a supplementary service information can be sent at a later stage by using a correct signaling determined on the basis of the stored connection information.

1. A method for providing a supplementary call service in a telecommunication network, comprising the steps of:
a) monitoring on a signaling path between end terminals (5, 12) a negotiation signaling of respective call parties;
b) storing a connection information detected in said monitoring step;
c) using said detected connection information to generate a signaling towards at least one of said end terminals (5, 12) to establish said supplementary call service, when said supplementary call service is invoked by one of said call parties.

2. A method according to claim 1, wherein said supplementary call service is applied to a data call.

3. A method according to claim 2, wherein said data call is a video or a multimedia call.

4. A method according to claim 1, wherein said supplementary call service is a call hold supplementary service.

5. A method according to claim 4, wherein said connection information defines a protocol used between said call parties.

6. A method according to claim 4, wherein said signaling for establishing said call hold supplementary service comprises sending empty or fill frames or supervisory data link layer frames according to said connection information to one of said call parties in order to keep a connection protocol alive.

7. A method according to claim 4, further comprising resynchronization attempts towards one of said call parties and stopping a related timer in order to prevent a call failure.

8. A method according to claim 4, wherein said signaling for establishing said call hold supplementary service comprises sending a video information or an audio information to one of said call parties.

9. A method according to claim 8, wherein said video information comprises a still or moving video information.

10. A method according to claim 4, wherein said negotiation signaling is monitored by a mobile terminal (11) connected to one (12) of said end terminals.

11. A method according to claim 1, wherein said supplementary call service is a call transfer supplementary service.

12. A method according to claim 11, wherein said connection information defines a transcoding parameter.

13. A method according to claim 12, wherein said transcoding parameter defines a type of audio and/or video codec.

14. A method according to claim 11, wherein said signaling for establishing said call transfer supplementary service comprises a fallback signaling for converting a connection to one of said call parties into a speech mode.

15. A method according to claim 14, wherein said fallback signaling is performed towards both call parties, if said connection information indicates that two data calls cannot be adapted.

16. A method according to claim 11, wherein said signaling for establishing said call transfer supplementary service comprises transmitting a codec parameter derived from said connection information to a network element having a transcoding capability, in order to provide a required a transcoding function at said network element.

17. A method according to claim 16, wherein said codec parameter is transmitted to said network element, if a fallback signaling to one of said call parties has failed.

18. A method according to claim 11, further comprising indicating changes of call characteristics to an upper layer entity, recognizing an application level compatibility of the transferred calls, and performing interworking in said upper layer entity.

19. A method according to claim 1, wherein said signaling for establishing said supplementary service is performed by an interworking function provided in said telecommunication network.

20. A method according to claim 1, wherein said telecommunication network is a mobile network.

21. A method according to claim 1, wherein said connection information is at least partly received through an outband signaling.

22. An apparatus for providing a supplementary call service in a telecommunication network, comprising:
a) monitoring means (34) for monitoring on a signaling path between end terminals (5, 12) a negotiation signaling of respective call parties;
b) storing means (35) for storing a connection information detected by said monitoring means (34); and
c) signaling means (32, 33) for generating a signaling towards at least one of said end terminals (5, 12) to establish said supplementary call service in response to said stored connection information, when said supplementary call service is invoked by one of said call parties.

23. An apparatus according to claim 22, wherein said signaling means (32, 33) is adapted to send empty or fill frames or supervisory data link layer frames according to said connection information to one of said call parties, in order to keep a connection protocol alive.

24. An apparatus according to claim 22, wherein said signaling means (32, 33) is adapted to stop resynchronization attempts towards one of said call parties and to stop a related timer, in order to prevent a call failure.

25. An apparatus according to claim 22, wherein said signaling means (32, 33) is adapted to send a video information and/or an audio information to one of said call parties.

26. An apparatus according to claim 22, wherein said signaling means (32, 33) is adapted to generate a fallback signaling for converting a connection to one of said call parties into a speech mode.

27. An apparatus according to claim 26, wherein said signaling means (32, 33) is adapted to transmit a coded parameter to a network element (30) having a transcoding capability, in order to provide a required transcoding function at said network element (30).

28. An apparatus according to claim 22, wherein said signaling means (32, 33) is adapted to indicate changes of a call characteristic to an upper layer entity.

29. An apparatus according to claim 23, wherein said apparatus is a mobile terminal (11) connected to one (12) of said end terminals.

30. An apparatus according to claim 22, wherein said apparatus is an interworking unit (31).
